(19) United States
(12) Patent Application Publication
(10) Pub. No.: US 2024/0365177 A1
(43) Pub. Date: Oct. 31, 2024

(54) METHOD FOR DETERMINING CONFIGURATION INFORMATION, TERMINAL DEVICE AND CHIP

(71) Applicant: GUANGDONG OPPO MOBILE TELECOMMUNICATIONS CORP., LTD., Dongguan (CN)

(72) Inventors: Shukun WANG, Dongguan (CN); Jiangsheng FAN, Dongguan (CN); Teng MA, Dongguan (CN)

(21) Appl. No.: 18/765,575

(22) Filed: Jul. 8, 2024

Related U.S. Application Data
(63) Continuation of application No. PCT/CN2022/072144, filed on Jan. 14, 2022.

(51) Int. Cl. H04W 36/00

(52) U.S. Cl. CPC H04W 36/0007

(57) ABSTRACT

A method for determining configuration information, a terminal device, and a chip are provided. In the method, when a terminal device reselects a target cell by performing cell selection, target Multimedia Broadcast Service (MBS) configuration information is determined; and a multicast MBS is received based on the target MBS configuration information.

### CROSS-REFERENCE TO RELATED APPLICATION

This application is a continuation of International Patent Application No. PCT/CN2022/072144 filed on Jan. 14, 2022, the disclosure of which is hereby incorporated by reference in its entirety.

### RELATED ART

In the New Radio (NR) system, many scenarios need to support multicast-type and broadcast-type service requirements, such as internet of vehicles, industrial internet, and so on. Therefore, it is necessary to introduce multicast-type and broadcast-type Multimedia Broadcast Services (MBSs) into the NR.

Currently, a terminal device may only receive multicast MBSs in a Radio Resource Control (RRC) connected state. For energy conservation of the terminal device, the terminal device may receive multicast MBSs in an RRC inactive state. How to enable the terminal device to receive multicast MBSs in the RRC inactive state needs to be improved.

### SUMMARY

Embodiments of the disclosure provide a method for determining configuration information, a terminal device, and a chip.

A method for determining configuration information provided by an embodiment of the disclosure includes the following operations. When a terminal device reselects a target cell by performing cell selection, target MBS configuration information is determined, and a multicast MBS is received based on the target MBS configuration information.

A terminal device provided by an embodiment of the disclosure includes a processor and a memory, wherein the memory is configured to store a computer program, and the processor is configured to call and run the computer program stored in the memory to cause the terminal device to perform: determining, when the terminal device reselects a target cell by performing cell selection, target Multimedia Broadcast Service (MBS) configuration information; and receiving a multicast MBS based on the target MBS configuration information.

A chip provided by an embodiment of the disclosure includes a processor configured to call and run a computer program in a memory to enable a terminal device having installed thereon the chip to perform an operation of: determining, when a terminal device reselects a target cell by performing cell selection, target Multimedia Broadcast Service (MBS) configuration information, and receiving a multicast MBS based on the target MBS configuration information

### BRIEF DESCRIPTION OF THE DRAWINGS

The drawings illustrated herein are used to provide a further understanding of the disclosure and form a part hereof. Schematic embodiments of the disclosure and their illustrations are used to explain the disclosure and do not constitute an undue limitation of the disclosure.

FIG. 1 is a schematic diagram of an application scenario of an embodiment of the disclosure.

FIG. 2 is a schematic diagram of protocol stacks corresponding to a Point-To-Multipoint (PTM) manner and a Point-To-Point (PTP) manner of an embodiment of the disclosure.

FIG. 3 is a schematic flowchart of a method for determining configuration information provided by an embodiment of the disclosure.

FIG. 4 is a flowchart of obtaining updated MBS configuration information during an RRC recovery process provided by an embodiment of the disclosure.

FIG. 5 is a schematic diagram of a structure of an apparatus for determining configuration information provided by an embodiment of the disclosure.

FIG. 6 is a schematic diagram of a structure of a communication device provided by an embodiment of the disclosure.

FIG. 7 is a schematic diagram of structure of a chip of an embodiment of the disclosure.

FIG. 8 is a schematic block diagram of a communication system provided by an embodiment of the disclosure.

### DETAILED DESCRIPTION

The technical solutions in the embodiments of the disclosure will be described below in conjunction with the drawings in the embodiments of the disclosure. It is apparent that the described embodiments are a part of the embodiments of the disclosure and not all of the embodiments. Based on the embodiments of the disclosure, all other embodiments obtained by those of ordinary skill in the art without making creative labor fall within the scope of protection of the disclosure.

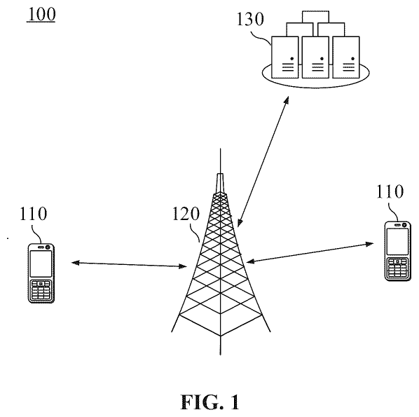

FIG. 1 is a schematic diagram of an application scenario of an embodiment of the disclosure.

As shown in FIG. 1, a communication system 100 may include a terminal device 110 and a network device 120. The network device 120 may communicate with the terminal device 110 by an air interface. Multi-service transmission is supported between the terminal device 110 and the network device 120.

It is to be understood that the embodiments of the disclosure are only illustrated exemplarily with the communication system 100, but are not limited thereto. That is, the technical solutions of the embodiments of the disclosure may be applied to various communication systems, for example, a Long Term Evolution (LTE) system, an LTE Time Division Duplex (TDD), a Universal Mobile Telecommunication System (UMTS), an Internet of Things (IoT) system, a Narrow Band Internet of Things (NB-IoT) system, an enhanced Machine-Type Communications (eMTC) system, a 5G communication system (also referred to as a New Radio (NR) communication system), a future communication system, or the like.

In the communication system 100 shown in FIG. 1, the network device 120 may be an access network device that communicates with the terminal device 110. The access network device may provide communication coverage for a specific geographic area and may communicate with a terminal device 110 (for example, a UE) located within the coverage area.

The network device 120 may be an Evolutional Node B (eNB or eNodeB) in an LTE system, a Next Generation Radio Access Network (NG RAN) device, a base station (gNB) in an NR system, or a radio controller in a Cloud Radio Access Network (CRAN). Alternatively, the network device 120 may be a relay station, an access point, an on-board device, a wearable device, a hub, a switch, a network bridge, a router, a network device in the future evolved Public Land Mobile Network (PLMN), or the like.

The terminal device 110 may be any terminal device, which includes, but is not limited to, a terminal device that has a wired or wireless connection to the network device 120 or other terminal devices.

For example, the terminal device 110 may refer to an access terminal, a User Equipment (UE), a user unit, a user station, a mobile station, a mobile platform, a remote station, a remote terminal, a mobile device, a user terminal, a terminal, a wireless communication device, a user agent, or a user apparatus. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device with a wireless communication function, a computing device or other processing devices connected to a wireless modem, an on-board device, a wearable device, a terminal device in a 5G network, a terminal device in a future evolution network, or the like.

The terminal device 110 may be used for Device to Device (D2D) communication.

The wireless communication system 100 may further include a core network device 130 that communicates with a base station. The core network device 130 may be a 5G Core (5GC) device, such as an Access and Mobility Management Function (AMF), an Authentication Server Function (AUSF), a User Plane Function (UPF), or a Session Management Function (SMF). Optionally, the core network device 130 may also be an Evolved Packet Core (EPC) device of the LTE network, for example, a Session Management Function+Core Packet Gateway (SMF+PGW-C) device. It is to be understood that the SMF+PGW-C is able to realize the functions that can be realized by the SMF and the PGW-C at the same time. In the process of network evolution, the above core network device may also be called by other names, or new network entities may be formed by dividing the functions of the core network, which is not limited by embodiments of the disclosure.

Communication may also be realized between various functional units in the communication system 100 by establishing a connection through a next generation (NG) interface.

For example, the terminal device establishes an air interface connection with the access network device through an NR interface for transmitting user plane data and control plane signalings. The terminal device may establish a control plane signaling connection with the AMF through NG interface 1 (abbreviated as N1). The access network device, such as a next-generation wireless access base station (gNB), may establish a user plane data connection with the UPF through NG interface 3 (abbreviated as N3). The access network device may establish a control plane signaling connection with the AMF through NG interface 2 (abbreviated as N2). The UPF may establish a control plane signaling connection with the SMF through NG interface 4 (abbreviated as N4). The UPF may exchange user plane data with the data network through NG interface 6 (abbreviated as N6). The AMF may establish a control plane signaling connection with the SMF through NG interface 11 (abbreviated as N11). The SMF may establish a control plane signaling connection with the PCF through NG interface 7 (abbreviated as N7).

FIG. 1 exemplarily illustrates a base station, a core network device, and two terminal devices. Optionally, the wireless communication system 100 may include multiple base station devices, and other numbers of terminal devices may be included within the coverage area of each base station, which is not limited by the embodiments of the disclosure.

It is to be noted that FIG. 1 only shows a system to which the disclosure applies by way of example, and of course, the method shown in the embodiments of the disclosure may be applied to other systems. In addition, the terms “system” and “network” may often be used interchangeably herein. The term “and/or” herein is only a description of an association relationship of associated objects, representing that there may be three kinds of relationships. For example, “A and/or B” may represent three conditions, i.e., independent existence of A, existence of both A and B, and independent existence of B. In addition, the character “/” herein usually represents that the previous and next associated objects are in an “or” relationship. It is further to be understood that the term “indicate” referred to in the embodiments of the disclosure may be a direct indication, an indirect indication, or may indicate an associated relationship. For example, “A indicates B” may mean that A directly indicates B, e.g., B may be obtained through A; or A indirectly indicates B, e.g., A indicates C and B may be obtained through C; or there is an associated relationship between A and B. It is further to be understood that the term “corresponding” referred to in the embodiments of the disclosure may represent a direct or indirect correspondence between the two, or may represent an associated relationship between the two, or a relationship between indicating and being indicated, configuring and being configured, or the like. It is further to be understood that the term “predefined” or “predefined rules” referred to in the embodiments of the disclosure may be achieved by storing in advance corresponding codes or forms in a device (e.g., including a terminal device and a network device), or other means that may be used to indicate relevant information. The specific implementation is not limited by the disclosure. For example, “predefined” may refer to being defined in a protocol. It is further to be understood that the “protocol” in the embodiments of the disclosure may refer to a standard protocol in the field of communication, which may include, for example, an LTE protocol, an NR protocol, and relevant protocols applied to future communication systems, which is not limited by the disclosure.

In order to facilitate the understanding of the technical solutions of the embodiments of the disclosure, relevant technologies of the embodiments of the disclosure are illustrated below. The following relevant technologies, as optional solutions, may be arbitrarily combined with the technical solutions of the embodiments of the disclosure, all of which belong to the scope of protection of the embodiments of the disclosure.

With the pursuit of rate, latency, high-speed mobility and energy efficiency from people, and with the diversity and complexity of services in future life, the 3rd Generation Partnership Project (3GPP) international standard organization has begun to research and develop 5G. Main application scenarios of 5G are enhanced Mobile Broadband (eMBB), Ultra-Reliable Low-Latency Communications (URLLC) and massive Machine-Type Communications (mMTC).

On one hand, the eMBB still aims to enable users to obtain multimedia contents, services and data, and the demand is growing very rapidly. On the other hand, the eMBB may be deployed in different scenarios, for example, indoor, urban area, rural area, or the like, and the difference in capability and demand is large, which thus cannot be generalized and must be analyzed in detail with specific deployment scenarios. Typical applications of the URLLC include: industrial automation, electric power automation, telemedicine operations (surgeries), traffic safety security, or the like. Typical characteristics of the mMTC include: high connection density, small data volume, delay-insensitive services, low cost and long lifetime of modules, or the like.

Multimedia Broadcast Multicast Service (MBMS) is a technology that transmits data from a data source to multiple terminal devices by sharing network resources. Such technology may provide multimedia services while making effective use of network resources to achieve broadcast and multicast of multimedia services with higher rates (e.g., 256 kbps).

The MBMS has a low spectrum efficiency, and thus is not sufficient to effectively carry and support operations of mobile TV type services. Therefore, in the LTE, 3GPP explicitly proposes to enhance the support capability for downlink high-speed MBMS services, and determines design requirements for physical layers and air interfaces.

3GPP R9 introduces the evolved MBMS (eMBMS) into the LTE. The eMBMS proposes a concept of Single Frequency Network (SFN), i.e. a Multimedia Broadcast multicast service Single Frequency Network (MBSFN). The MBSFN adopts a uniform frequency to send service data in all cells at the same time, but it is required to ensure synchronization between cells. Such manner may greatly improve overall signal-to-noise distribution of the cells, and the spectrum efficiency will be greatly improved correspondingly. The eMBMS achieves broadcast and multicast of services based on the IP multicast protocol.

In the LTE or LTE-Advanced (LTE-A), the MBMS only has a broadcast bearer mode, and does not have a multicast bearer mode.

It is to be noted that although the above solution is illustrated taking the MBMS as an example, the description of “MBMS” may also be replaced with “MBS”.

The embodiments of the disclosure are illustrated taking the MBS as an example, and the description of “MBS” may also be replaced with “MBMS”.

In the NR system, many scenarios need to support multicast-type and broadcast-type service requirements, such as internet of vehicles, industrial internet, and so on. Therefore, it is necessary to introduce multicast-type and broadcast-type MBSs into the NR. It is to be noted that multicast-type MBSs refer to MBSs transmitted in a multicast manner, and broadcast-type MBSs refer to MBSs transmitted in a broadcast manner.

For a multicast-type MBS, the network side configures configuration information received by the MBS (abbreviated as MBS configuration information) through an RRC-specific signalling. Optionally, the MBS configuration information includes at least one of identifier information of the MBS, a Group-Radio Network Temporary Identifier (Group-RNTI, G-RNTI), an MBS Radio Bearer (MRB) configuration, a physical channel configuration, a feedback resource configuration, or the like. For an MBS with a high requirement on the Quality of Service (QoS) (e.g., an MBS with a high reliability requirement), the terminal device is required to receive the multicast MBS in an RRC connected state. For a broadcast-type MBS, the network side configures the Multicast Control Channel (MCCH) through a system message (e.g., MBS or SIB), and configures the Multicast Transport Channel (MTCH) through an MCCH signalling. The terminal device may receive the broadcast MBS in the RRC connected state, an RRC idle state or an RRC inactive state.

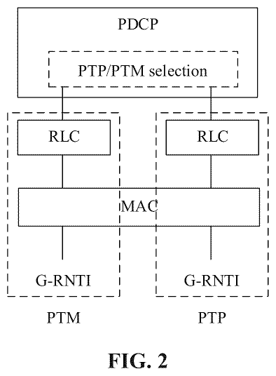

For a multicast-type MBS, the MBS is sent to all terminal devices in a group. The terminal device receives the multicast-type IBS in the RRC connected state, and the terminal device may receive multicast-type MBS data in a PTM manner or a PTP manner. Referring to FIG. 2, the MBS data in the PTM manner scrambles corresponding scheduling information through a G-RNTI configured by the network side, and the MBS data in the PTP manner scrambles corresponding scheduling information through a Cell-RNTI (C-RNTI). Optionally, there is a scenario where the PTP is used for the PTM retransmission during the transmission process of the MBS.

For a multicast-type MBS, after receiving the MBS distributed by the core network from a shared tunnel, the base station may distribute the MBS to all terminal devices in a group through an air interface. Here, the base station may distribute the MBS to all terminal devices in a group in the PTP manner and/or the PTM manner. For example, if a group includes terminal device 1, terminal device 2 and terminal device 3, the base station may distribute the MBS to terminal device 1 in the PTP manner, distribute the MBS to terminal device 2 in the PTP manner, and distribute the MBS to terminal device 3 in the PTP manner. Alternatively, the base station may distribute the MBS to terminal device 1 in the PTP manner, and distribute the MBS to terminal device 2 and terminal device 3 in the PTM manner. Alternatively, the base station may distribute the MBS to terminal device 1, terminal device 2 and terminal device 3 in the PTM manner. A shared GPRS Tunneling Protocol (GTP) tunnel is adopted between the core network and the base station to transmit the MBS, i.e., both the MBS in the PTM manner and the MBS in the PTP manner share this GTP tunnel. The base station distributes MBS data to UE1 and UE2 according to the PTM manner, and distributes MBS data to UE3 according to the PTP manner.

For a multicast-type MBS (abbreviated as a multicast MBS, a Discontinuous Reception (DRX) mechanism is introduced for energy conservation of the terminal device. For ease of differentiation, a DRX used for reception of MBS multicast services is referred to as an MBS DRX (or a multicast DRX), and a DRX used for reception of conventional unicast services is referred to as a unicast DRX. The MBS DRX and the unicast DRX are independent of each other. As an example, parameters associated with the MBS DRX may be referred to Table 1 below. The network side may configure the parameters shown in Table 1 through an RRC signalling, so as to control the MBS DRX operation through these parameters. It is to be noted that the MBS DRX is configured per G-RNTI or per G-CS-RNTI. For the terminal device, the DRX activation time includes the run time of the following timers: drx-onDurationTimerPTM, drx-InactivityTimerPTM, and drx-RetransmissionTimer-DL-PTM.

TABLE 1
drx-onDurationTimerPTM: the duration at the beginning of a DRX cycle;
drx-SlotOffsetPTM: the delay before starting the drx-onDurationTimerPTM;
drx-InactivityTimerPTM: the duration after the PDCCH occasion in which a PDCCH
indicates a new DL multicast transmission for the MAC entity;
drx-LongCycleStartOffsetPTM: the long DRX cycle drx-LongCycle-PTM and drx-StartOffset-
PTM which defines the subframe where the long DRX cycle starts;
drx-RetransmissionTimer-DL-PTM (per DL HARQ process for multicast MBS) : the
maximum duration until a DL multicast retransmission is received;
drx-HARQ-RTT-Timer-DL-PTM (per DL HARQ process for multicast MBS) : the minimum
duration before a DL multicast assignment for HARQ retransmission is expected by the MAC
entity;

For the purpose of reducing the signalling of the air interface, quickly recovering wireless connection, and quickly recovering data services, 5G defines a new RRC state, i.e., the RRC inactive (RRC_INACTIVE) state. Such state is different from the RRC idle (RRC_IDLE) state and the RRC active (RRC_ACTIVE) state.

1) In the RRC_IDLE state (abbreviated as an idle state), mobility is cell selection reselection based on the terminal device. The paging is initiated by the Core Network (CN), and the paging area is configured by the CN. No UE context and no RRC connection exists on the base station side.

2) In the RRC_CONNECTED state (abbreviated as a connected state), an RRC connection exists, and UE context exists on the base station side and the terminal device side. The network side knows the location of the terminal device at a level of a specific cell. Mobility is mobility controlled by the network side. Unicast data may be transmitted between the terminal device and the base station.

3) In the RRC_INACTIVE state (abbreviated as an inactive state), mobility is cell selection reselection based on the terminal device, and connection between CN-NR exists. UE AS context exists on a certain base station. The paging is triggered by the RAN, and the RAN-based paging area is managed by the RAN. The network side knows the location of the terminal device at a level of the RAN-based paging area.

When the terminal device is in the RRC inactive state, the network side (RAN) configures a paging area of the RAN for the terminal device through an RRC-specific signalling, and the paging area of the RAN may be one cell or multiple cells. The terminal device does not have to notify the network side when it moves within this area, and follows the mobility behavior in the RRC idle state, i.e., the cell selection reselection principle. When the terminal device moves out of the paging area of the RAN, the terminal device is triggered to recover the RRC connection and re-obtain the paging area of the RAN. When downlink data arrives at the terminal device, the base station that maintains the connection between the RAN and the CN for the terminal device triggers all cells in the paging area of the RAN to send a paging message to the terminal device, such that the terminal device in the RRC inactive state may recover the RRC connection to perform data reception.

Therefore, there are three cases as follows in which the terminal device enters the RRC connected state from the RRC inactive state.

In a first case, downlink data arrives at the terminal device, and the network side initiates an RAN initial paging to prompt the terminal device to enter the RRC connected state.

In a second case, the terminal device itself initiates an RAN location area update, such as a periodic RAN location update or a cross-area location update.

In a third case, the terminal device has an uplink data transmission requirement, which prompts the terminal device to enter the RRC connected state.

The flow of the RRC recovery process is as follows.

1. The terminal device sends a preamble code to the current service base station.

2. The current service base station sends a random access response (RAR) to the terminal device.

3. The terminal device sends an RRC recovery request message to the current service base station.

4. The current service base station interacts with the base station that stores UE context of the terminal device and retrieves the UE context.

5. The current service base station sends an RRC recovery message to the terminal device.

6. The terminal device sends an RRC recovery completion message to the current service base station.

Currently, the terminal device may only receive the multicast MBS in the RRC connected state. For energy conservation of the terminal device, the terminal device may receive the multicast MBS in the RRC inactive state. However, the configuration information received by the MBS (abbreviated as MBS configuration information) is configured for the terminal device through the RRC-specific signalling. Therefore, when cell selection reselection occurs during the process that the terminal device receives the multicast MBS in the RRC inactive state, how to obtain MBS configuration information of the target cell is a problem to be solved. The following technical solutions of the embodiments of the disclosure are thus proposed.

To facilitate the understanding of the technical solutions of the embodiments of the disclosure, the technical solutions of the disclosure are described in detail below with specific embodiments. The above relevant technologies, as optional solutions, may be arbitrarily combined with the technical solutions of the embodiments of the disclosure, all of which belong to the scope of protection of the embodiments of the disclosure. The embodiments of the disclosure include at least part of the following contents.

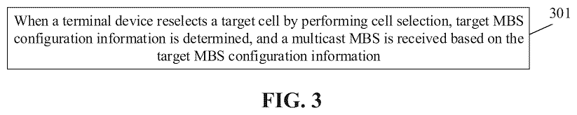

FIG. 3 is a schematic flowchart of a method for determining configuration information provided by an embodiment of the disclosure. As shown in FIG. 3, the method for determining the configuration information includes the following operations.

In operation 301, when a terminal device reselects a target cell by performing cell selection, target MBS configuration information is determined, and a multicast MBS is received based on the target MBS configuration information.

In some optional implementations, the network side may configure at least one piece of indicative information through a first signalling. The indicative information is used to indicate whether the terminal device is capable of continuing to receive the MBS in the RRC inactive state. Optionally, the indicative information may be configured per G-RNTI, i.e., each G-RNTI is associated with a respective piece of indicative information. For the terminal device, the terminal device receives the first signalling, and the first signalling is used to configure at least one piece of indicative information. The indicative information is used to indicate whether the terminal device is capable of continuing to receive the multicast MBS in the RRC inactive state. Optionally, the first signalling is an RRC-specific signalling, for example. the first signalling is an RRCReconfiguration message or an RRCRelease message.

In some optional implementations, each piece of indicative information of the at least one piece of indicative information is associated with a respective G-RNTI. In other words, the indicative information is configured per G-RNTI. For example, indicative information 1 (associated with G-RNTI 1) is used to indicate that the terminal device is capable of continuing to receive the multicast MBS in the RRC inactive state, and the G-RNTI of the MBS here is G-RNTI 1 associated with indicative information 1. Indicative information 2 (associated with G-RNTI 2) is used to indicate that the terminal device is not capable of continuing to receive the multicast MBS in the RRC inactive state, and the G-RNTI of the MBS here is G-RNTI 2 associated with indicative information 2.

In some optional implementations, the at least one piece of indicative information includes first indicative information. The first indicative information is associated with a first G-RNTI, and the first indicative information is used to indicate that the terminal device is capable of continuing to receive the multicast MBS in the RRC inactive state. After entering the RRC inactive state, the terminal device performs at least one of the following behaviors.

Keeping an MRB associated with the first G-RNTI unsuspended;
performing a partial Media Access Control (MAC) reset; or
keeping a DRX operation associated with the first G-RNTI to be continuously performed.

Here, the operation that the DRX operation associated with the first G-RNTI is kept to be continuously performed may also be understood as an operation that a DRX timer (referring to a DRX timer other than a Round-Trip Time (RTT) timer or a retransmission timer) associated with the first G-RNTI is kept unaffected. if a DRX configuration associated with the first G-RNTI includes a configuration of an RTT timer and/or a retransmission timer, the terminal device ignores the configuration of the RTT timer and/or the retransmission timer. Alternatively, if an RTT timer and/or a retransmission timer associated with the first G-RNTI is running, the terminal device stops the RTT timer and/or the retransmission timer.

It is to be noted that the MAC reset means that when an MAC entity is requested to be reset by a higher layer entity, the MAC entity performs the entries shown in Table 2 below.

TABLE 2

| | |
|---|---|
| 1> | initialize Bj for each logical channel to zero; |
| 1> | initialize SBj for each logical channel to zero if Sidelink resource allocation |

mode 1 is configured by RRC;

| | |
|---|---|
| 1> | stop (if running) all timers; |
| 1> | consider all timeAlignmentTimers as expired and perform the corresponding |

actions in clause 5.2;

| | |
|---|---|
| 1> | set the NDIs for all uplink HARQ processes to the value 0; |
| 1> | sets the NDIs for all HARQ process IDs to the value 0 for monitoring PDCCH |

in Sidelink resource allocation mode 1;

| | |
|---|---|
| 1> | stop, if any, ongoing Random Access procedure; |
| 1> | discard explicitly signalled contention-free Random Access Resources for 4- |

step RA type and 2-step RA type, if any;

| | |
|---|---|
| 1> | flush Msg3 buffer; |
| 1> | flush MSGA buffer; |
| 1> | cancel, if any, triggered Scheduling Request procedure; |
| 1> | cancel, if any, triggered Buffer Status Reporting procedure; |
| 1> | cancel, if any, triggered Power Headroom Reporting procedure; |
| 1> | cancel, if any, triggered consistent LBT failure; |
| 1> | cancel, if any, triggered BFR; |
| 1> | cancel, if any, triggered Sidelink Buffer Status Reporting procedure; |
| 1> | cancel, if any, triggered Pre-emptive Buffer Status Reporting procedure; |
| 1> | cancel, if any, triggered Recommended bit rate query procedure; |
| 1> | cancel, if any, triggered Configured uplink grant confirmation; |
| 1> | cancel, if any, triggered configured sidelink grant confirmation; |
| 1> | cancel, if any, triggered Desired Guard Symbol query; |
| 1> | flush the soft buffers for all DL HARQ processes; |
| 1> | for each DL HARQ process, consider the next received transmission for a TB |
| as the very first transmission; | |
| 1> | release, if any, Temporary C-RNTI; |
| 1> | reset all BFI_COUNTERs; |
| 1> | reset all LBT_COUNTERs. |

For a PC5-RRC connection, if the MAC entity is requested for a sidelink-specific reset by the higher layer, the MAC entity performs the entries shown in Table 3 below.

TABLE 3

| | |
|---|---|
| 1> | flush the soft buffers for all Sidelink processes for all TB(s) associated to the |

PC5-RRC connection;

| | |
|---|---|
| 1> | consider all Sidelink processes for all TB(s) associated to the PC5-RRC |

connection as unoccupied;

| | |
|---|---|
| 1> | cancel, if any, triggered Scheduling Request procedure only associated to the |

PC5-RRC connection;

| | |
|---|---|
| 1> | cancel, if any, triggered Sidelink Buffer Status Reporting procedure only |

associated to the PC5-RRC connection;

| | |
|---|---|
| 1> | cancel, if any, triggered Sidelink CSI Reporting procedure associated to the |

PC5-RRC connection;

| | |
|---|---|
| 1> | stop (if running) all timers associated to the PC5-RRC connection; |
| 1> | reset the numConsecutiveDTX associated to the PC5-RRC connection; |
| 1> | initialize SBj for each logical channel associated to the PC5-RRC connection |

to zero.

In the embodiment of the disclosure, the partial MAC reset means an MAC reset with some entries not performed. As an example, the MAC is reset, but the following actions with respect to a Downlink Hybrid Automatic Repeat-reQuest (DL HARQ) are not performed.
1> flush the soft buffers for all DL HARQ processes;
1> for each DL HARQ process, consider the next received transmission for a TB as the very first transmission.

In some optional implementations, the at least one piece of indicative information includes second indicative information. The second indicative information is associated with a second G-RNTI, and the second indicative information is used to indicate that the terminal device is not capable of continuing to receive the multicast MBS in the RRC inactive state. After entering the RRC inactive state, the terminal device performs at least one of the following behaviors.

Suspending an MBS radio bearer associated with the second G-RNTI; or
stopping performing a DRX operation associated with the second G-RNTI.

As an example, indicative information 1 (associated with G-RNTI 1) is used to indicate that the terminal device is capable of continuing to receive the multicast MBS in the RRC inactive state, and the G-RNTI of the MBS here is G-RNTI 1 associated with indicative information 1. After entering the RRC inactive state, the terminal device performs at least one of the following behaviors. Keeping the MRB associated with G-RNTI 1 unsuspended; performing the partial MAC reset; or keeping the DRX operation associated with G-RNTI 1 (i.e., the DRX operation corresponding to the MBS) to be continuously performed. Indicative information 2 (associated with G-RNTI 2) is used to indicate that the terminal device is not capable of continuing to receive the multicast MBS in the RRC inactive state, and the G-RNTI of the MBS here is G-RNTI 2 associated with indicative information 2. After entering the RRC inactive state, the terminal device performs at least one of the following behaviors. Suspending the MBS radio bearer associated with G-RNTI 2; or stopping performing the DRX operation associated with G-RNTI 2.

In some optional implementations, after entering an RRC idle state from the RRC inactive state, the terminal device releases UE context and autonomously enters the RRC connected state. The terminal device obtains the MBS configuration information in the RRC connected state, and receives the multicast MBS based on the MBS configuration information. Here, there are various reasons for the terminal device to enter the RRC idle state from the RRC inactive state, for example, the terminal device enters the RRC idle state from the RRC inactive state due to an abnormality. In such case, the terminal device releases UE AS context including context of MBS data, and autonomously enters the RRC connected state to continue to obtain the MBS configuration information, and to continue to receive the MBS according to the MBS configuration information.

With the above solution, the terminal device may know through the first signalling which MBSs may be continuously received in the RRC inactive state.

In the embodiment of the disclosure, the mobility behavior of the terminal device in the RRC inactive state follows the cell selection reselection. When the terminal device reselects the target cell by performing the cell selection, the target MBS configuration information is determined, and the multicast MBS is received based on the target MBS configuration information. How the terminal device determines the MBS configuration information is illustrated below. It is to be noted that the “target MBS configuration information” in the embodiments of the disclosure may also be understood as updated MBS configuration information.

In a first solution, the network configures MBS configuration information per area.

In some optional implementations, the terminal device receives a second signalling, and the second signalling is used to configure at least one piece of MBS configuration information. When the terminal device reselects the target cell by performing the cell selection, the target MBS configuration information is obtained based on the second signalling. Specifically, the second signalling is used to configure first MBS configuration information, and the second signalling is further used to configure first area information. The first area information is used to indicate a first area in which the first MBS configuration information is valid.

Here, optionally, the MBS configuration information includes at least one of identifier information of the MBS, a G-RNTI, an MRB radio bearer configuration, frequency domain resource information when the MBS multicast service is received, an physical channel configuration, an feedback resource configuration, or the like.

Here, optionally, the first area information includes at least one of a cell identifier list, a Radio Access Network Notification Area (RNA) list, or a system broadcast area identifier.

Here, optionally, the second signalling is an RRC-specific signalling, and the second signalling may be the same as or different from the first signalling in the aforementioned solution. For example, the second signalling is an RRCReconfiguration message or an RRCRelease message.

As an example, the terminal device receives configuration information about multicast MBS reception (i.e., the first MBS configuration information) sent by the network side through the RRC-specific signalling in the RRC connected state.

Furthermore, the RRC-specific signalling configures a piece of area information (i.e., the first area information), and the first area information is used to indicate the first area in which the MBS configuration information is valid. When the terminal device reselects a cell by performing the cell selection within the first area, there is no need to re-obtain the MBS configuration information, and the previous MBS configuration information (i.e., the MBS configuration information obtained through the RRC-specific signalling) is still valid.

In some optional implementations, when the terminal device reselects the target cell by performing the cell selection, if the target cell is located in the first area, the first MBS configuration information is determined as the target MBS configuration information.

In some optional implementations, if the target cell is located outside the first area, the terminal device initiates an RRC recovery process, and the target MBS configuration information is obtained through the RRC recovery process.

In a second solution, the network configures MBS configuration information per cell.

In some optional implementations, the terminal device receives a second signalling, and the second signalling is used to configure at least one piece of MBS configuration information. When the terminal device reselects the target cell by performing the cell selection, the target MBS configuration information is obtained based on the second signalling. Specifically, each piece of MBS configuration information of the at least one piece of MBS configuration information is associated with a respective cell identifier information, and the MBS configuration information is valid within a cell corresponding to the associated cell identifier information.

Here, optionally, the MBS configuration information includes at least one of the identifier information of the NBS, the G-RNTI, the MRB radio bearer configuration, the frequency domain resource information when the NBS multicast service is received, the physical channel configuration, the feedback resource configuration, or the like.

Herein, optionally, the cell identifier information includes at least one of a cell identifier, a frequency, or a Physical Cell Identity (PCI).

In some optional implementations, when the terminal device reselects the target cell by performing the cell selection, if cell identifier information of the target cell matches cell identifier information associated with the first NBS configuration information in the at least one piece of MBS configuration information, the first MBS configuration information is determined as the target MBS configuration information.

In some optional implementations, if the cell identifier information of the target cell does not match cell identifier information associated with any NMBS configuration information in the at least one piece of MBS configuration information, the terminal device initiates the RRC recovery process, and the target MBS configuration information is obtained through the RRC recovery process.

As an example, the terminal device receives configuration information about multicast NBS reception through the RRC-specific signalling in the RRC connected state. The RRC-specific signalling configures multiple pieces of MBS configuration information, and each piece of configuration information is associated with a respective piece of cell identifier information. When the terminal device reselects the target cell by performing the cell selection, if the cell identifier information of the target cell matches cell identifier information associated with one piece of the multiple pieces of NMBS configuration information, the terminal device enables the MBS configuration information associated with the cell identifier information. If it does not match, the terminal device initiates the RRC recovery process and obtains updated NMBS configuration information through the RRC recovery process.

In a third solution, the MBS configuration information is updated through a 2 step RRC resume process.

In some optional implementations, when the terminal device reselects the target cell by performing the cell selection, the RRC recovery process is initiated, and the target MBS configuration information is obtained through the RRC recovery process.

In some optional implementations, the network side configures the updated MBS configuration information through an RRC release message, and the terminal device obtains the target MBS configuration information through the RRC release message.

As an example, when the terminal device reselects the target cell by performing the cell selection, the RRC recovery process is initiated, and the updated MBS configuration information is obtained through the RRC recovery process.

For any of the above solutions, the operation that the terminal device obtains the target MBS configuration information through the RRC recovery process or the RRC release message includes the following operations. The terminal device sends an RRC recovery request message to a first base station, and the first base station is a base station corresponding to the target cell. The terminal device receives the RRC release message from the first base station, and the RRC release message carries the updated MBS configuration information. The terminal device determines the updated MBS configuration information as the target MBS configuration information.

Here, optionally, after the terminal device sends the RRC recovery request message to the first base station, the first base station sends a retrieve UE context request message to a second base station. The second base station is a base station on which UE context of the terminal device is stored. The first base station receives a retrieve UE context response message sent by the second base station, and the retrieve UE context response message carries the UE context of the terminal device. The first base station updates the MBS configuration information based on the UE context of the terminal device.

In the aforementioned solution, optionally, the RRC recovery request message carries a recovery reason, and the value of the recovery reason is a first reason value. The first reason value is used to indicate that the purpose of the terminal device initiating the RRC recovery is for updating the MBS configuration information.

In the aforementioned solution, optionally, the retrieve UE context request message carries a first reason value, and the first reason value is used to indicate that the purpose of the terminal device initiating the RRC recovery is for updating the MBS configuration information.

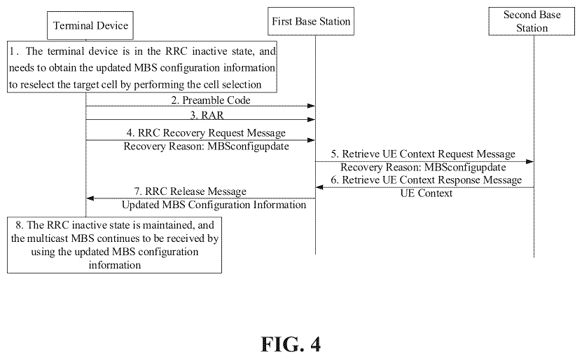

FIG. 4 shows a flow of obtaining the updated MBS configuration information during the RRC recovery process. As shown in FIG. 4, the flow includes the following operations.

In operation 1, the terminal device is in the RRC inactive state, and needs to obtain the updated MBS configuration information (i.e., the configuration information received by the multicast MBS) to reselect the target cell by performing the cell selection.

In operation 2, the terminal device sends a preamble code to the first base station.

Here, the first base station is the base station where the terminal device currently serves, i.e., the base station corresponding to the target cell.

In operation 3, the first base station sends an RAR to the terminal device.

In operation 4, the terminal device sends the RRC recovery request message to the first base station, and the RRC recovery request message carries the recovery reason that is MBSconfigupdate.

Here, MBSconfigupdate is the first reason value, and is used to indicate that the purpose of the terminal device initiating the RRC recovery is for updating the MBS configuration information.

In operation 5, after receiving the RRC recovery request message, the first base station knows through the recovery reason that the purpose of the terminal device initiating the RRC recovery is for updating the to-be-updated MBS configuration information due to the cell selection reselection, and thus sends, according to an inactive-RNTI (I-RNTI), the retrieve UE context request message to the second base station that stores the UE context of the terminal device. The retrieve UE context request message carries the recovery reason that is MBSconfigupdate.

In operation 6, the second base station sends the retrieve UE context response message to the first base station, and the retrieve UE context response message carries the UE context.

In operation 7, the first base station updates the MBS configuration information according to the configuration information of the multicast MBS in the UE context, and configures the updated MBS configuration information to the terminal device through the RRC release message.

In operation 8, the terminal device maintains the RRC inactive state, replaces the previous MBS configuration information with the updated MBS configuration information in the RRC release message, and continues to receive the multicast MBS by the updated MBS configuration information.

In the embodiments of the disclosure, in order to satisfy service continuity, in other words, to enable the terminal device to reselect a cell on which the MBS being received by the terminal device exists as far as possible, so as to ensure the continuity of reception of the MBS, the terminal device reselects a cell by performing the cell selection with reference to a frequency priority. Specifically, for a terminal device that enters the RRC inactive state and receives the MBS, during the process of cell reselection, the terminal device considers that the frequency corresponding to the current cell has the highest priority, or determines the frequency with the highest priority based on frequency priority configuration information for the reception of the MBS configured by the network side, and then reselects a cell by performing the cell selection according to the frequency with the highest priority.

In some optional implementations, for any one of the aforementioned first solution, second solution and third solution, the RRC release message further carries the frequency priority configuration information. The frequency priority configuration information is used for the terminal device to reselect a cell by performing the cell selection for the MBS. Further, if the MBS ends, the terminal device releases the frequency priority configuration information.

Here, the RRC release message carries a frequency priority specific configuration (i.e., the frequency priority configuration information) set by the terminal device to ensure the continuity of the MBS. The terminal device reselects a cell by performing the cell selection with such configuration, so as to ensure that a cell with the MBS is preferentially reselected. If the MBS ends, the terminal device releases the frequency priority configuration information.

In some optional implementations, for any one of the aforementioned first solution, second solution and third solution, the RRC release message further carries third indicative information. The third indicative information is used to indicate that the terminal device is capable of continuing to receive the multicast MBS in the RRC inactive state and/or that the current cell has the highest frequency priority. The third indicative information is used for the terminal device to reselect a cell by performing the cell selection for the MBS.

Here, the RRC release message carries a piece of indicative information for indicating that the terminal device is capable of continuing to receive the multicast MBS when returning to the RRC inactive state. After the terminal device receives the RRC release message and enters the RRC inactive state, according to the indicative information, the terminal device may consider that the frequency where the current cell is located has the highest priority, and reselect a cell by performing the cell selection accordingly.

In some optional implementations, for the aforementioned third solution, the RRC release message further carries a first list of neighbor cells in which an MBS exists. If the terminal device determines that the MBS does not exist in a neighbor cell of cell reselection based on the first list of neighbor cells, the terminal device enters the RRC connected state and receives the MBS in the RRC connected state. If the terminal device determines that the MBS exists in the neighbor cell of the cell reselection based on the first list of neighbor cells, the terminal device performs the cell reselection and continues to receive the MBS in a neighbor cell that is reselected by the cell reselection.

Here, the network side configures in the RRC release message a list of neighbor cells in which an MBS exists (referred to as the first list of neighbor cells). If the terminal device determines, according to the list of neighbor cells, that the MBS does not exist in the neighbor cell of the cell reselection before reselecting a cell by performing the cell selection, the terminal device enters the RRC connected state to receive the MBS, and then continues to receive the MBS by means of switching. If the MBS exists in the neighbor cell of the cell reselection, the terminal device continues to receive the MBS by means of cell reselection.

In some optional implementations, when the terminal device determines that an MBS ends, at least one of the following behaviors is performed.

Stopping listening scheduling information of an MBS scrambled by a G-RNTI;
releasing bearer configuration associated with the G-RNTI; or
releasing MBS configuration information associated with the G-RNTI.

In the above solution, the operation that the terminal device determines that the MBS ends may be implemented in the following manners.

In a first manner, the terminal device determines, based on an MAC Control Element (CE) sent by the network side, that the MBS ends. The MAC CE is used to notify that the MBS ends.

In a first option, the MAC CE carries identifier information of the MBS. The terminal device determines the ended MBS based on the identifier information of the MBS carried in the MAC CE.

In a second option, the terminal device determines the ended MBS based on a G-RNTI that schedules a PDCCH corresponding to the MAC CE. Here, optionally, the MAC CE only includes an MAC CE subheader.

As an example, if the MBS ends, the network notify that the MBS ends through the MAC CE. After knowing that the MBS ends, the terminal device stops listening the MBS scrambled by the G-RNTI, and/or autonomously releases the bearer configuration associated with the G-RNTI and all associated MBS configurations. As an implementation, the MAC CE includes the identifier information of the released (i.e. stopped) MBS, such as a Temporary Mobile Group Identifier (TMGI) or a G-RNTI. As another implementation, the G-RNTI, based on which the PDCCH corresponding to the MAC CE is scheduled (or scrambled), implicitly instructs to release (i.e. stop) the MBS corresponding to the G-RNTI. In such case, the MAC CE may be an MAC CE with only the MAC CE subheader and no MAC CE contents, i.e. it is determined through the subheader of the MAC CE that the network side ends a certain MBS.

In a second manner, the terminal device determines, based on a timer configured by the network side, that the MBS ends. Here, optionally, the timer is configured for a G-RNTI, or the timer is configured for multiple MBSs.

Specifically, when receiving the PDCCH that schedules the MBS, the terminal device starts or restarts the timer. If the timer expires, it is determined that the MBS ends.

As an example, the network side configures a timer. If the terminal device receives MBS scheduling data (i.e., the PDCCH scrambled by the G-RNTI), the terminal device restarts the timer. If the timer expires, it indicates that the MBS ends. The timer here may be configured per G-RNTI, or all MBSs may be configured with one timer.

The preferred implementations of the disclosure are described in detail above in combination with the drawings, but the disclosure is not limited to the specific details in the above implementations. Within the scope of the technical conception of the disclosure, a variety of simple variations of the technical solutions of the disclosure may be carried out, and all of these simple variations fall within the scope of protection of the disclosure. For example, various specific technical features described in the above specific implementations may be combined in any suitable manner without contradiction, and in order to avoid unnecessary repetition, various possible combinations are not separately illustrated in the disclosure. Further, for example, various different implementations of the disclosure may also be arbitrarily combined, and as long as they do not contradict the idea of the disclosure, they should be regarded as the contents disclosed in the disclosure. Further, for example, on the premise of no conflict, the various embodiments and/or technical features in the various embodiments described in the disclosure may be arbitrarily combined with the related art, and the technical solutions obtained after the combination shall also fall within the scope of protection of the disclosure.

It is further to be understood that in various method embodiments of the disclosure, the magnitude of the serial numbers of the above processes does not imply the order of execution, and the order of execution of the processes shall be determined by their functions and internal logic, and shall not constitute any limitation on the implementation process of the embodiments of the disclosure. Furthermore, in the embodiments of the disclosure, the terms “downlink”, “uplink” and “sidelink” are used to represent a transmission direction of signals or data. “Downlink” is used to represent that the transmission direction of signals or data is a first direction from the site to the user device of the cell, “uplink” is used to represent that the transmission direction of signals or data is a second direction from the user device of the cell to the site, and “sidelink” is used to represent that the transmission direction of signals or data is a third direction from user device 1 to user device 2. For example, a “downlink signal” represents that the signal is transmitted in the first direction. In addition, in the embodiments of the disclosure, the term “and/or” is only a description of an association relationship of associated objects, representing that there may be three kinds of relationships. For example, “A and/or B” may represent three conditions, i.e., independent existence of A, existence of both A and B, and independent existence of B. In addition, the character “/” herein usually represents that the previous and next associated objects are in an “or” relationship.

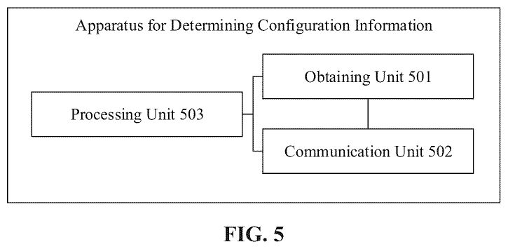

FIG. 5 is a schematic structure composition diagram of an apparatus for determining configuration information provided by an embodiment of the disclosure, and the apparatus is applied to a terminal device. As shown in FIG. 5, the apparatus for determining the configuration information includes an obtaining unit 501 and a communication unit 502.

The obtaining unit 501 is configured to determine, when the terminal device reselects a target cell by performing cell selection, target MBS configuration information.

The communication unit 502 is configured to receive a multicast MBS based on the target MBS configuration information.

In some optional implementations, the communication unit 502 is further configured to receive a first signalling. The first signalling is used to configure at least one piece of indicative information, and the indicative information is used to indicate whether the terminal device is capable of continuing to receive the multicast MBS in an RRC inactive state.

In some optional implementations, each piece of indicative information of the at least one piece of indicative information is associated with a respective G-RNTI.

In some optional implementations, the at least one piece of indicative information includes first indicative information. The first indicative information is associated with a first G-RNTI, and the first indicative information is used to indicate that the terminal device is capable of continuing to receive the multicast MBS in the RRC inactive state.

The apparatus further includes a processing unit 503. The processing unit 503 is configured to perform at least one of the following behaviors after the terminal device enters the RRC inactive state.

Keeping an MBS radio bearer associated with the first G-RNTI unsuspended;
performing a partial MAC reset; or
keeping a DRX operation associated with the first G-RNTI to be continuously performed.

In some optional implementations, the processing unit 503 is further configured to: if a DRX configuration associated with the first G-RNTI includes a configuration of an RTT timer and/or a retransmission timer, ignore the configuration of the RTT timer and/or the retransmission timer; and if an RTT timer and/or a retransmission timer associated with the first G-RNTI is running, stop the RTT timer and/or the retransmission timer.

In some optional implementations, the at least one piece of indicative information includes second indicative information. The second indicative information is associated with a second G-RNTI, and the second indicative information is used to indicate that the terminal device is not capable of continuing to receive the multicast MBS in the RRC inactive state.

The apparatus further includes the processing unit 503. The processing unit 503 is configured to perform at least one of the following behaviors after the terminal device enters the RRC inactive state.

Suspending an MBS radio bearer associated with the second G-RNTI; or
stopping performing a DRX operation associated with the second G-RNTI.

In some optional implementations, the processing unit 503 is further configured to release UE context and autonomously enters an RRC connected state after the terminal device enters an RRC idle state from the RRC inactive state.

The obtaining unit 501 is further configured to obtain MBS configuration information when the terminal device is in the RRC connected state. The communication unit 502 is further configured to receive the multicast MBS based on the MBS configuration information.

In some optional implementations, the first signalling is an RRC-specific signalling.

In some optional implementations, the communication unit 502 is further configured to receive a second signalling, and the second signalling is used to configure at least one piece of MBS configuration information. The obtaining unit 501 is configured to obtain, when the terminal device reselects the target cell by performing the cell selection, the target MBS configuration information based on the second signalling.

In some optional implementations, the second signalling is used to configure first MBS configuration information, and the second signalling is further used to configure first area information. The first area information is used to indicate a first area in which the first MBS configuration information is valid.

In some optional implementations, the first area information includes at least one of a cell identifier list, an RNA list, or a system broadcast area identifier.

In some optional implementations, the obtaining unit 501 is configured to: when the terminal device reselects the target cell by performing the cell selection, if the target cell is located in the first area, determine the first MBS configuration information as the target MBS configuration information.

In some optional implementations, the obtaining unit 501 is further configured to: if the target cell is located outside the first area, initiate an RRC recovery process, and obtain the target MBS configuration information through the RRC recovery process.

In some optional implementations, each piece of MBS configuration information of the at least one piece of MBS configuration information is associated with a respective piece of cell identifier information, and the MBS configuration information is valid within a cell corresponding to the associated cell identifier information.

In some optional implementations, the cell identifier information includes at least one of a cell identifier, a frequency, or a PCI.

In some optional implementations, the obtaining unit 501 is configured to: when the terminal device reselects the target cell by performing the cell selection, if cell identifier information of the target cell matches cell identifier information associated with the first MBS configuration information in the at least one piece of MBS configuration information, determine the first MBS configuration information as the target MBS configuration information.

In some optional implementations, the obtaining unit 501 is further configured to: if the cell identifier information of the target cell does not match cell identifier information associated with any MBS configuration information in the at least one piece of MBS configuration information, initiate the RRC recovery process, and obtain the target MBS configuration information through the RRC recovery process.

In some optional implementations, the obtaining unit 501 is configured to: when the terminal device reselects the target cell by performing the cell selection, initiate the RRC recovery process, and obtain the target MBS configuration information through the RRC recovery process.

In some optional implementations, the communication unit 502 is further configured to send an RRC recovery request message to a first base station, and the first base station is a base station corresponding to the target cell. The communication unit 502 is further configured to receive an RRC release message from the first base station, and the RRC release message carries updated MBS configuration information. The obtaining unit 501 determines the updated MBS configuration information as the target MBS configuration information.

In some optional implementations, the RRC recovery request message carries a recovery reason, and the value of the recovery reason is a first reason value. The first reason value is used to indicate that the purpose of the terminal device initiating the RRC recovery is for updating the MBS configuration information.

In some optional implementations, the first base station sends a retrieve UE context request message to a second base station, and the second base station is a base station on which UE context of the terminal device is stored. The first base station receives a retrieve UE context response message sent by the second base station, and the retrieve UE context response message carries the UE context of the terminal device. The first base station updates the MBS configuration information based on the UE context of the terminal device.

In some optional implementations, the retrieve UE context request message carries the first reason value. The first reason value is used to indicate that the purpose of the terminal device initiating the RRC recovery is for updating the MBS configuration information.

In some optional implementations, the RRC release message further carries frequency priority configuration information. The frequency priority configuration information is used for the terminal device to reselect a cell by performing the cell selection for the MBS.

In some optional implementations, the processing unit 503 is further configured to release the frequency priority configuration information if the MBS ends.

In some optional implementations, the RRC release message further carries third indicative information. The third indicative information is used to indicate that the terminal device is capable of continuing to receive the multicast MBS in the RRC inactive state and/or that the current cell has the highest frequency priority, and the third indicative information is used for the terminal device to reselect a cell by performing the cell selection for the MBS.

In some optional implementations, the RRC release message further carries a first list of neighbor cells in which an MBS exists. The communication unit 502 is further configured to enter the RRC connected state and receive the MBS in the RRC connected state if it is determined that the MBS does not exist in a neighbor cell of cell reselection based on the first list of neighbor cells. The communication unit 502 is further configured to perform the cell reselection and continue to receive the MBS in a neighbor cell that is reselected by the cell reselection if it is determined that the MBS exists in the neighbor cell of the cell reselection based on the first list of neighbor cells.

In some optional implementations, the processing unit 503 is further configured to perform at least one of the following behaviors when it is determined that the MBS ends.

Stopping listening scheduling information of an MBS scrambled by a G-RNTI;
releasing bearer configuration associated with the G-RNTI; or
releasing MBS configuration information associated with the G-RNTI.

In some optional implementations, the processing unit 503 is configured to determine, based on an MAC CE sent by a network side, that the MBS ends. The MAC CE is used to notify that the MBS ends.

In some optional implementations, the MAC CE carries identifier information of the MBS. The processing unit 503 is configured to determine the ended MBS based on the identifier information of the MBS carried in the MAC CE.

In some optional implementations, the processing unit 503 is configured to determine the ended MBS based on a G-RNTI that schedules a PDCCH corresponding to the MAC CE.

In some optional implementations, the MAC CE only includes an MAC CE subheader.

In some optional implementations, the processing unit 503 is configured to determine, based on a timer configured by the network side, that the MBS ends.

In some optional implementations, the processing unit 503 is configured to start or restart the timer if the communication unit 502 receives a PDCCH scheduling the MBS, and determine that the MBS ends if the timer expires.

In some optional implementations, the timer is configured for a G-RNTI, or the timer is configured for multiple MBSs.

It is to be understood by those skilled in the art that the related description of the aforementioned apparatus for determining the configuration information of the embodiments of the disclosure may be understood with reference to the related description of the method for determining the configuration information of the embodiments of the disclosure.

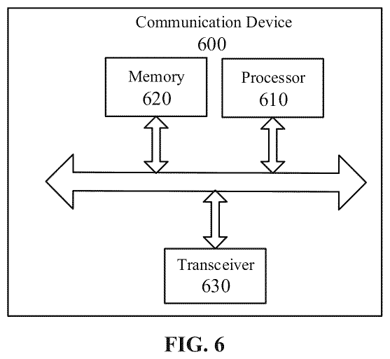

FIG. 6 is a schematic diagram of structure of a communication device 600 provided by an embodiment of the disclosure. The communication device may be a terminal device or a network device. The communication device 600 shown in FIG. 6 includes a processor 610. The processor 610 may call and run a computer program in a memory to implement the methods in the embodiments of the disclosure.

Optionally, as shown in FIG. 6, the communication device 600 may further include a memory 620. The processor 610 may call and run a computer program in the memory 620 to implement the methods in the embodiments of the disclosure.

The memory 620 may be a separate component independent of the processor 610, or may be integrated into the processor 610.

Optionally, as shown in FIG. 6, the communication device 600 may further include a transceiver 630. The processor 610 may control the transceiver 630 to communicate with other devices, specifically, to send information or data to other devices, or to receive information or data sent by other devices.

The transceiver 630 may include a transmitter and a receiver. The transceiver 630 may further include antennas. The number of antennas may be one or more.

Optionally, the communication device 600 may specifically be the network device of the embodiments of the disclosure, and the communication device 600 may implement the corresponding flows implemented by the network device in each method of the embodiments of the disclosure, which is not repeated here for the sake of brevity.

Optionally, the communication device 600 may specifically be the mobile terminal or terminal device of the embodiments of the disclosure, and the communication device 600 may implement the corresponding flows implemented by the mobile terminal or terminal device in each method of the embodiments of the disclosure, which is not repeated here for the sake of brevity.

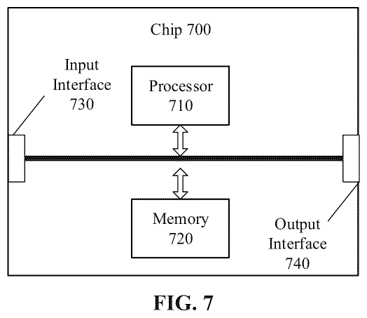

FIG. 7 is a schematic diagram of structure of a chip of an embodiment of the disclosure. The chip 700 shown in FIG. 7 includes a processor 710. The processor 710 may call and run a computer program in a memory to implement the methods in the embodiments of the disclosure.

Optionally, as shown in FIG. 7, the chip 700 may further include a memory 720. The processor 710 may call and run a computer program in the memory 720 to implement the methods in the embodiments of the disclosure.

The memory 720 may be a separate component independent of the processor 710, or may be integrated into the processor 710.

Optionally, the chip 700 may further include an input interface 730. The processor 710 may control the input interface 730 to communicate with other devices or chips, specifically, to obtain information or data sent by other devices or chips.

Optionally, the chip 700 may further include an output interface 740. The processor 710 may control the output interface 740 to communicate with other devices or chips, specifically, to output information or data to other devices or chips.

Optionally, the chip may be applied to the network device of the embodiments of the disclosure, and the chip may implement corresponding flows implemented by the network device in each method of the embodiments of the disclosure, which is not repeated here for the sake of brevity.

Optionally, the chip may be applied to the mobile terminal or terminal device of the embodiments of the disclosure, and the chip may implement corresponding flows implemented by the mobile terminal or terminal device in each method of the embodiments of the disclosure, which is not repeated here for the sake of brevity.

It is to be understood that the chip referred to in the embodiments of the disclosure may also be referred to as a system-level chip, a system chip, a chip system, a system-on-chip, or the like.

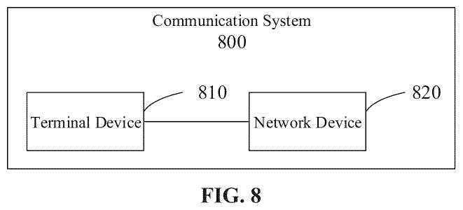

FIG. 8 is a schematic block diagram of a communication system 800 provided by an embodiment of the disclosure. As shown in FIG. 8, the communication system 800 includes a terminal device 810 and a network device 820.

The terminal device 810 may be configured to implement corresponding functions implemented by the terminal device in the aforementioned methods, and the network device 820 may be configured to implement corresponding functions implemented by the network device in the aforementioned methods, which is not repeated here for the sake of brevity.

It is to be understood that the processor in the embodiments of the disclosure may be an integrated circuit chip with a signal processing capability. In an implementation process, various operations in the aforementioned method embodiments may be completed by a hardware integrated logic circuit or instructions in the form of software in the processor. The above processor may be a general purpose processor, a Digital Signal Processor (DSP), an Application Specific Integrated Circuit (ASIC), a Field Programmable Gate Array (FPGA) or other programmable logic devices, discrete gates or transistor logic devices, or discrete hardware components. Various methods, operations and logic block diagrams disclosed in the embodiments of the disclosure may be implemented or executed. The general purpose processor may be a microprocessor, or the processor may be any conventional processor or the like. Operations in combination with methods disclosed in the embodiments of the disclosure may be directly embodied to be executed and completed by a hardware decoding processor, or by a combination of hardware and software modules in the decoding processor. The software module may be located in a mature storage medium in the art, such as a Random Access Memory, a flash memory, a Read-Only Memory, a Programmable Read-Only Memory, an Electrically Erasable Programmable Memory, a register, or the like. The storage medium is located in the memory, and the processor reads the information in the memory to complete the operations of the aforementioned methods in combination with its hardware.

It is to be understood that the memory in the embodiments of the disclosure may be a volatile memory or a non-volatile memory, or may include a volatile memory and a non-volatile memory. Here, the non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), and is used as an external high-speed cache. It is exemplarily but unlimitedly illustrated that RAMs in various forms may be used, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) or a Direct Rambus RAM (DR RAM). It is to be noted that the memory of the systems and methods described herein is intended to include memories of these and any other proper types, but is not limited thereto.

It is to be understood that the above memory is exemplarily but unlimitedly illustrated. For example, the memory in the embodiments of the disclosure may further be an SRAM, a DRAM, an SDRAM, a DDR SDRAM, an ESDRAM, an SLDRAM, a DR RAM, or the like. That is, the memory in the embodiments of the disclosure is intended to include memories of these and any other proper types, but is not limited thereto.

An embodiment of the disclosure further provides a computer-readable storage medium configured to store a computer program.

Optionally, the computer-readable storage medium may be applied to the network device of the embodiments of the disclosure, and the computer program enables a computer to execute corresponding flows implemented by the network device in each method of the embodiments of the disclosure, which is not repeated here for the sake of brevity.

Optionally, the computer-readable storage medium may be applied to the mobile terminal or terminal device of the embodiments of the disclosure, and the computer program enables a computer to execute corresponding flows implemented by the mobile terminal or terminal device in each method of the embodiments of the disclosure, which is not repeated here for the sake of brevity.

An embodiment of the disclosure further provides a computer program product, which includes computer program instructions.

Optionally, the computer program product may be applied to the network device of the embodiments of the disclosure, and the computer program instructions enable a computer to execute corresponding flows implemented by the network device in each method of the embodiments of the disclosure, which is not repeated here for the sake of brevity.

Optionally, the computer program product may be applied to the mobile terminal or terminal device of the embodiments of the disclosure, and the computer program instructions enable a computer to execute corresponding flows implemented by the mobile terminal or terminal device in each method of the embodiments of the disclosure, which is not repeated here for the sake of brevity.

An embodiment of the disclosure further provides a computer program.

Optionally, the computer program may be applied to the network device of the embodiments of the disclosure, and when the computer program runs in a computer, the computer program enables the computer to execute corresponding flows implemented by the network device in each method of the embodiments of the disclosure, which is not repeated here for the sake of brevity.

Optionally, the computer program may be applied to the mobile terminal or terminal device of the embodiments of the disclosure, and when the computer program runs in a computer, the computer program enables the computer to execute corresponding flows implemented by the mobile terminal or terminal device in each method of the embodiments of the disclosure, which is not repeated here for the sake of brevity.

Those of ordinary skill in the art may realize that the units and algorithm steps of each example described in combination with the embodiments disclosed herein may be implemented by electronic hardware, or a combination of computer software and electronic hardware. Whether these functions are executed in a hardware or software manner depends on specific applications and design constraints of the technical solutions.

Professionals may implement the described functions for each specific application by using different methods, but such implementation shall not be regarded as outside the scope of the disclosure.

Those skilled in the art may clearly understand that for convenient and brief description, specific operation processes of the systems, apparatuses and units described above may refer to corresponding processes in the aforementioned method embodiments and will not be repeated here.

In several embodiments provided by the disclosure, it is to be understood that the disclosed systems, apparatuses and methods may be implemented in other manners.

For example, the apparatus embodiments described above are only schematic. For example, division of the units is only a kind of logic function division, and other division manners may be adopted during a practical implementation. For example, multiple units or components may be combined or integrated into another system, or some features may be neglected or not executed. In addition, coupling or direct coupling or communication connection between various displayed or discussed components may be indirect coupling or communication connection through some interfaces, apparatuses or units, and may be electrical, mechanical, or in other forms.

Units described as separate components may or may not be physically separated, and components displayed as units may or may not be physical units, that is, may be located in the same place, or may also be distributed to multiple network units.

Part or all of the units may be selected according to a practical requirement to implement the purpose of the solutions of the embodiments.

In addition, various functional units in various embodiments of the disclosure may be integrated into a processing unit, or each unit may physically exist independently, or two or more than two units may be integrated into a unit.

When implemented in form of a software functional unit and sold or used as an independent product, the functions may be stored in a computer-readable storage medium. Based on such understanding, the technical solutions of the disclosure substantially or parts making contributions to the related art or part of the technical solutions may be embodied in form of a software product. The computer software product is stored in a storage medium, including several instructions for enabling a computer device (which may be a personal computer, a server, a network device, or the like) to execute all or part of the operations of the methods in various embodiments of the disclosure. The abovementioned storage medium includes various media capable of storing program codes, such as a USB disk, a mobile hard disk, a ROM, a RAM, a magnetic disk, an optical disk, or the like.

The above are only specific implementations of the disclosure, but the scope of protection of the disclosure is not limited thereto. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for determining configuration information, comprising:
determining, when a terminal device reselects a target cell by performing cell selection, target Multimedia Broadcast Service (MBS) configuration information, and receiving a multicast MBS based on the target MBS configuration information.

2. The method of claim 1, further comprising:
receiving, by the terminal device, a first signalling, wherein the first signalling is used to configure at least one piece of indicative information, and the indicative information is used to indicate whether the terminal device is capable of continuing to receive the multicast MBS in a Radio Resource Control (RRC) inactive state.

3. The method of claim 2, wherein each piece of indicative information of the at least one piece of indicative information is associated with a respective Group-Radio Network Temporary Identifier (G-RNTI).

4. The method of claim 2, wherein the at least one piece of indicative information comprises first indicative information, the first indicative information is associated with a first G-RNTI, and the first indicative information is used to indicate that the terminal device is capable of continuing to receive the multicast MBS in the RRC inactive state;
wherein the method further comprises: performing, after the terminal device enters the RRC inactive state, at least one of:
keeping an MBS radio bearer associated with the first G-RNTI unsuspended;
performing a partial Media Access Control (MAC) reset; or
keeping a Discontinuous Reception (DRX) operation associated with the first G-RNTI to be continuously performed.

5. The method of claim 4, wherein
if a DRX configuration associated with the first G-RNTI comprises a configuration of a Round-Trip Time (RTT) timer and/or a retransmission timer, ignoring, by the terminal device, the configuration of the RTT timer and/or the retransmission timer; and
if an RTT timer and/or a retransmission timer associated with the first G-RNTI is running, stopping, by the terminal device, the RTT timer and/or the retransmission timer.

6. The method of claim 2, wherein the at least one piece of indicative information comprises second indicative information, the second indicative information is associated with a second G-RNTI, and the second indicative information is used to indicate that the terminal device is not capable of continuing to receive the multicast MBS in the RRC inactive state;
wherein the method further comprises: performing, after the terminal device enters the RRC inactive state, at least one of:
suspending an MBS radio bearer associated with the second G-RNTI; or
stopping performing a DRX operation associated with the second G-RNTI.

7. The method of claim 4, further comprising:
after the terminal device enters an RRC idle state from the RRC inactive state, releasing User Equipment (UE) context, and autonomously entering an RRC connected state; and
obtaining, by the terminal device, MBS configuration information in the RRC connected state, and receiving the multicast MBS based on the MBS configuration information.

8. The method of claim 2, wherein the first signalling is an RRC-specific signalling.

9. The method of claim 1, wherein determining, when the terminal device reselects the target cell by performing the cell selection, the target MBS configuration information comprises:
receiving, by the terminal device, a second signalling, wherein the second signalling is used to configure at least one piece of MBS configuration information; and
obtaining, when the terminal device reselects the target cell by performing the cell selection, the target MBS configuration information based on the second signalling.

10. The method of claim 9, wherein the second signalling is used to configure first MBS configuration information, the second signalling is further used to configure first area information, and the first area information is used to indicate a first area in which the first MBS configuration information is valid.

11. The method of claim 10, wherein the first area information comprises at least one of a cell identifier list, a Radio Access Network Notification Area (RNA) list, or a system broadcast area identifier,
wherein obtaining, when the terminal device reselects the target cell by performing the cell selection, the target MBS configuration information based on the second signalling comprises:
when the terminal device reselects the target cell by performing the cell selection, if the target cell is located in the first area, determining the first MBS configuration information as the target MBS configuration information,
the method further comprises:
if the target cell is located outside the first area, initiating, by the terminal device, an RRC recovery process, and obtaining the target MBS configuration information through the RRC recovery process.

12. A terminal device, comprising a processor, and a memory, wherein the memory is configured to store a computer program, and the processor is configured to call and run the computer program stored in the memory to cause the terminal device to perform:
determining, when the terminal device reselects a target cell by performing cell selection, target Multimedia Broadcast Service (MBS) configuration information; and
receiving a multicast MBS based on the target MBS configuration information.

13. The terminal device of claim 12, wherein the terminal device is further configured to receive a first signalling, wherein the first signalling is used to configure at least one piece of indicative information, and the indicative information is used to indicate whether the terminal device is capable of continuing to receive the multicast MBS in a Radio Resource Control (RRC) inactive state.

14. The terminal device of claim 13, wherein each piece of indicative information of the at least one piece of indicative information is associated with a respective Group-Radio Network Temporary Identifier (G-RNTI).

15. The terminal device of claim 13, wherein the at least one piece of indicative information comprises first indicative information, the first indicative information is associated with a first G-RNTI, and the first indicative information is used to indicate that the terminal device is capable of continuing to receive the multicast MBS in the RRC inactive state;
wherein the processor is further configured to call and run the computer program stored in the memory to cause the terminal device to perform, after the terminal device enters the RRC inactive state, at least one of:
keeping an MBS radio bearer associated with the first G-RNTI unsuspended;
performing a partial Media Access Control (MAC) reset; or
keeping a Discontinuous Reception (DRX) operation associated with the first G-RNTI to be continuously performed.

16. The terminal device of claim 13, wherein the at least one piece of indicative information comprises second indicative information, the second indicative information is associated with a second G-RNTI, and the second indicative information is used to indicate that the terminal device is not capable of continuing to receive the multicast MBS in the RRC inactive state;
wherein the processor is further configured to call and run the computer program stored in the memory to cause the terminal device to perform, after the terminal device enters the RRC inactive state, at least one of:
suspending an MBS radio bearer associated with the second G-RNTI; or
stopping performing a DRX operation associated with the second G-RNTI.

17. The terminal device of claim 13, wherein the first signalling is an RRC-specific signalling.

18. The terminal device of claim 12, wherein the processor is further configured to call and run the computer program stored in the memory to cause the terminal device to perform operations of:
when determining the target MBS configuration information, sending an RRC recovery request message to a first base station, wherein the first base station is a base station corresponding to the target cell; and
receiving an RRC release message from the first base station, wherein the RRC release message carries updated MBS configuration information, and the processor determines the updated MBS configuration information as the target MBS configuration information.

19. The terminal device of claim 18, wherein the RRC recovery request message carries a recovery reason, a value of the recovery reason is a first reason value, and the first reason value is used to indicate that a purpose of the terminal device initiating an RRC recovery is for updating MBS configuration information.

20. A chip, comprising a processor configured to call and run a computer program in a memory to enable a terminal device having installed thereon the chip to perform an operation of:
determining, when a terminal device reselects a target cell by performing cell selection, target Multimedia Broadcast Service (MBS) configuration information, and receiving a multicast MBS based on the target MBS configuration information.
